(19) United States
(12) Patent Application Publication
(10) Pub. No.: US 2021/0086363 A1
(43) Pub. Date: Mar. 25, 2021

(54) System and process for precisely fitting the assembly of components

(71) Applicant: WKW Engineering GmbH, Wuppertal (DE)

(72) Inventors: Thomas Stertkamp, Wuppertal (DE); Elisabeth Bouikidou, Velbert (DE); Peter Kubina, Langenfeld (DE); Stefan Hackländer, Essen (DE)

(21) Appl. No.: 16/948,456

(22) Filed: Sep. 18, 2020

(30) Foreign Application Priority Data
Sep. 19, 2019 (DE) 10 2019 125 229.6

(51) Int. Cl. B25J 9/16; B25J 19/02

(52) U.S. Cl. CPC B25J 9/1687; B25J 19/022; B25J 9/1671; B25J 9/1653

(57) ABSTRACT

The invention relates to a system and a method for precisely fitting component assembly, namely the precisely fitting installation of a second component on a first component. The invention relates in particular to corresponding systems and methods for precisely fitting component assembly of components on motor vehicles. It is achieved that a contact section of a second component and a contact section of an already assembled first component show no offset or no visible edge after assembly.

The invention relates to a system and a method for precisely fitting the assembly of components, namely the precise fitting of the installation of a second component onto a first component. The invention relates in particular to corresponding systems and methods for precisely fitting component assembly of components on motor vehicles.

### BACKGROUND

Components for a component unit are generally manufactured individually and processed according to requirements. It is known to allow a tolerance in the dimensions for the final shape of such machined components. If, after production and processing, it is established that this permissible tolerance has been exceeded in at least one measured value, the component in question is reworked or scrapped. Components with measured values within the permissible tolerance range are approved for assembly. If two components that have a permissible tolerance are brought together in one structural unit, it can nevertheless lead to a result that area where the components fit together does not have the desired appearance in the contact or connection area with other components. For example, it is undesirable to have a non-optimal edge, an offset or a joint that is too wide between two components. The mere step of forcing compliance with permitted dimensional tolerances does not ensure the avoidance of a joining area that is optically non-optimal. If the approach chosen for avoiding optically non-optimal joining areas is the further narrowing of dimensional tolerances for both of the components, then this makes the components much more expensive.

What would be desirable is to precisely fit such components without the need of imposing otherwise unnecessarily narrow dimensional tolerances.

### DETAILED DESCRIPTION

The new method for precisely fitting component assembly of a second component to a first component comprises, in a known manner, the production of the two components including machining each of the components to a desired final shape. These process steps take place according to specified requirements with regard to the material, the shape of the component and the surface design of selected surfaces of the component. Target dimensions are specified for the final shape of the machined components.

After production and especially after the last processing step for each of the components, the components are measured. In this case, at least the section of the component that comes to rest on another component is essential for the precisely fitting component assembly. This section is referred to below as the component contact section. After the components have been measured, the actual data is available for each component, or at least for each contact section of the components. The measurement of the components includes, in particular, the acquisition of actual spatial geometry data (3D data), but also of surface parameters. Examples of surface parameters that can be measured include degree of gloss determined with a reflectometer, or a color value determined with a color measuring device. The geometry data can be recorded with 3D scanners or using tactile methods. It is preferred to measure the external geometry, e.g. the height, width and/or length of a component, e.g. of an aluminum profile in order to optimize a joint area between two components if necessary. If two components are put into each other during component assembly, internal geometry data are also of interest. Using tactile technology, e.g. by means of a 3-D coordinate measuring device or by means of a probe arm, measuring points that lie on a line can be recorded. Another possibility is to use a 3D scanner, e.g. a laser scanner to cover a larger area, e.g. the outer contour of a component. Instead of scanning the entirety of a component, it is possible to scan merely selected areas of a component. For example if there is a contact section that will make contact with another component, the scanning can take place starting from a component end, which represents a joint edge as a transition to another component, continuing a distance of a few centimeters away from this component edge. Such a 3D scanner can also be easily integrated into an existing processing method for a component, and it can supply precise geometric data.

The actual data of the components obtained during a measurement step are stored, preferably in a computer-aided system or a data processing system. In order to transfer this data from the production site of the components to the assembly site, component-specific data records are then transmitted via an interface, each record being indicative of the place where a respective component is stored as well as the actual geometry data for the respective component and measured surface parameters for the respective component.

Such a data processing system also offers the possibility of comparing the actual data recorded in this way for the components with the default values for these components. The default values of the components represent the values that result from the nominal dimensions of the components and the permissible tolerance ranges for each nominal dimension. The comparison of the actual data with the default values can, however, also take place within the scope of quality assurance. In this way, the components are selected whose actual data is within the permissible tolerance range. The selected components are transported to the component assembly site. Components whose component-specific data is not within the accepted tolerance ranges are rejected. Components for which dimensions or surface parameters can be corrected and can be reworked. Tolerance deviations in the production, for example of an aluminum profile, can result from material defects and process-related tolerances during extrusion or bending. When machining such an aluminum profile, e.g. to obtain a decorative, anodized component surface, mechanical polishing, in particular, but also chemical process steps such as polishing, anodizing and compacting lead to dimensional deviations. If a component consists of two individual parts that are joined together via a form-fitting, force-fitting or material connection, these process steps also have an influence on the final shape of the component.

The components selected for transport to the location of component assembly are stored in storage units, each storage unit comprising several storage positions for the respective components. These can be known packaging units, transport units or other containers. Various storage containers can be used as storage units for metallic profile components, which also have decorative surfaces due to processing. Such storage containers have support and fixation points or fixation surfaces in accordance with the component geometry. Component storage is generally only possible in a predetermined position of the component, so that a component with a decorative surface cannot be inadvertently placed in the wrong position. As many components as possible per container volume are accommodated in a storage container, on the one hand for reasons of transport economy but also in order to have the largest possible selection of second components for the optimization of assembly. For example, roof frame strips for a motor vehicle are accommodated in storage units with 16 storage positions. Such a roof frame strip represents a second component, for example, and is mounted on a body of a vehicle in such a way that this roof frame strip adjoins the already mounted trim strip of the rear side window. The aim is that the contact section of such a roof frame strip (second component) and the contact section of the already installed decorative strip of the side window (first component) do not show any offset or a visible edge after installation.

In a preferred embodiment of the method, the permitted components are placed in these storage units according to a predetermined algorithm. It is advantageous to store a storage algorithm or the individual storage positions at the same time as storing these components, e.g. by means of the data processing device. This makes it possible to transfer the actual data of the components together with the storage algorithm or the storage positions of the individual components to the location of the component assembly, e.g. via a data transmission line if the component assembly does not take place at the same location as the production and processing of the components The first and second components and their actual data as well as at least one type of component, e.g. the second components, including their storage positions in the storage units.

To prepare for the component assembly of a second component on a first component or in attachment to a first component, the actual data from at least one attachment section of a first component is compared with all actual data from attachment sections of the existing second components stored in the storage units. When comparing the actual data of the first component with the actual data of all the second components, an optimal tolerance value can be achieved in the following manner. A data processing device is used for s purpose. In this comparison, a suitable second component is determined which, together with this first component, shows the smallest tolerance deviation in the joining area and promises an offset-free installation of the system sections of the two components in the assembled state. For example, the distances between the scanned system sections of the two components are used and the sum of the deviation or the sum of the squared deviation is calculated from this. This sum is determined for all second components and that second component which leads to the smallest deviation sum is then extracted from the storage unit as a suitable second component. If necessary, the surface parameters are compared in the same way and are taken into account as part of the selection process.

In order to extract this matching second component from one or more storage units, this component must be identified. For this purpose, the storage position of this component in one of the existing storage units is forwarded to a marking device via the data processing device. The marking device marks the matching second component and thus enables this matching component to be identified for extraction. In the simplest case, the appropriate second components are extracted manually from the respective storage unit. To identify this second component, a marking is made, for example using a laser pointer. Since the laser pointer is coupled to the data processing device, which knows the storage position of the second component, an individual illumination of the selected, matching second component is possible. For this purpose, the laser pointer coupled with the data processing device directs the laser beam onto the appropriate second component. Such marking and identification requires a firmly defined positioning of the storage units in relation to the laser pointer and the storage of the positions of the storage units as well as the geometry of the storage units including the storage position of the components located therein as data, e.g. in the data processing device.

Another possibility for manual extraction of the respectively matching second components can be done using AR (augmented reality) glasses. Such augmented reality glasses offer computer-aided perception in which the actually existing storage units and a virtual image of these storage units are visually superposed. A graphic of the respective storage unit is displayed via the data processing system and the information relating to the identified matching second component o assembly is displayed in the field of vision of the glasses. For the wearer of the glasses, a corresponding marking is faded into the perceived environment of the storage unit, for example an arrow which points to the next component to be removed from the container. Just as with the above described approach using a laser pointer, it is important to have a firmly defined positioning of the storage unit, as well as having firmly defined positions for the storage of the geometry of the storage container and the storage position of the second components located therein.

In a further embodiment of the method according to the invention, the extraction takes place automatically. With such an automated extraction, for example, a gripper device is connected to the data processing system. Here, too, as in the previous two discussions, a defined position of the storage units is a prerequisite for the targeted removal of the appropriate second components, namely a defined position of the storage units relative to the gripper device. The data processing device provides the gripper of the gripper device with the information as to which suitable second component is to be extracted and then transferred to the assembly site.

Once the appropriate second component has been extracted, this second component can be precisely fitted to the first component, as precisely as possible in the desired position to the first component.

In a preferred embodiment, the first component is already mounted on the overall unit, for example a first motor vehicle component is attached to the body. After the suitable second component has been selected and extracted from storage, it is mounted at the intended location with its contact section in the desired position relative to the contact section of the first component.

With this new method, the components can have tolerances both in the lower range and in the upper tolerance range. By capturing the component-specific data (geometry data, surface parameters) of both components and selecting a second component with known tolerance values that match the tolerances of a first component, it can be achieved that the joining area between the two components is significantly improved in spite of the existing tolerances in the measured actual data of the two components. As has been discussed, to make this work what needs to happen is the acquisition of the actual data of the components or component areas, a defined storage of the second components in the storage units, and the transfer of the corresponding data to the component assembly location, where a suitable second component is then selected for a first component and this component is identified in the selection unit.

The new process can be carried out with all process steps in one place if the production of the components, the processing of the components and the assembly of the components to form an overall unit are carried out in one place in a company. The manufacture and processing of the components away from the installation site are possible in the same way. At the assembly site, a system for precisely fitting component assembly is advantageously provided in order to utilize the advantages of the new method.

This facility includes
a data processing facility,
at least one storage unit,
a marking device connected to the data processing device,
if necessary, an identification device for a manual or an automatic extraction device and a mounting location, preferably with a mounting device for the assembly and the precisely fitting contact of a contact section of a second component onto a contact section of a first component.

The data processing device is used to record measured or transferred actual data of the components and to compare the actual data from at least a contact section of the first component with all actual data from contact sections of the second components in storage units, so that the second component can be determined which together with a first component has the smallest total tolerance deviation.

The storage units store at least the second components in defined storage positions. These storage units are at a location that defines an extraction position. The storage positions of the second components in connection with the location, i.e. the extraction position of the storage units are stored in the data processing device. In the same way, storage units can also be provided for the first components.

The marking device can mark a second component selected by the data processing device for manual or automatic extraction from the storage unit. For example, the marking device is a laser pointer, which marks a selected second component for manual extraction by illuminating it.

In one embodiment of the system, the identification device is AR glasses which, via a connection to the data processing device, receive an image of the storage unit at the defined removal position. This image is preferably a marking which shows the matching second component to be extracted.

In the case of automatic assembly, the second components are preferably also automatically extracted and a gripper device is provided for this purpose, which is part of the assembly device or interacts with the assembly device.

1. A method for precisely fitting the assembly of a second component to a first component, the method carried out with respect to a site of component assembly, the method comprising:
production of first and second components each having a desired respective final shape and each having desired respective surface properties, target dimensions of which are specified, the second components each having a contact section for contact with a contact section of a first component,
measuring geometric shapes of at least the contact sections of the components and obtaining actual data for geometric shapes of each contact section of the components,
saving the actual geometric shape data for each component,
comparing the actual geometric shape data of the components with default values for the components, whereby the default values are formed from the nominal dimensions of the components including a permissible tolerance range,
selecting components corresponding to the default values and storing of at least the second components in a storage unit which comprises several storage positions, the storage position in the storage unit of each second component being recorded,
transporting the components to the site of component assembly and transferring the associated data of these components including the storage positions of the second components by means of a data processing device to the site of component assembly,
preparing the component assembly by comparing the actual data from the system section of a first component with all the actual data from system sections of the second components present in one or more storage units by means of a data processing device, in particular comparing the tolerance deviations of both system sections from their target data,
selecting a second component which, together with this first component, results in a smallest total tolerance deviation of the contact sections of the two components in the assembled state, thus defining a matching second component,
marking and identifying this matching second component in the storage unit,
extracting this matching second component from the storage unit,
mounting the extracted second component in the desired position relative to the firs component.

2. The method according to claim 1, characterized in that in order to obtain actual data, geometry data and/or surface parameters of the components are measured.

3. The method according to claim 1, characterized in that production of the second and first components takes place at different geographic locations.

4. The method according to claim 1, characterized in that the existing tolerance deviations of each component are determined from the actual data and default values for the components and the data processing device stores the actual data and tolerance deviations.

5. The method according to claim 1, characterized in a the storage of the second components in the storage units takes place according to a predetermined algorithm and the data processing device determines and stores storage positions of the second components from this algorithm.

6. The method according to claim 1, characterized in that the extraction of the components from the storage unit takes place manually.

7. The method according to claim 1, characterized in that the selected second component storage unit is individually illuminated by a laser pointer for manual extraction, the laser pointer being coupled to the data processing device.

8. The method according to claim 1, characterized in that the marking and identification of the selected second component takes place by means of AR glasses.

9. The method according to claim 1, characterized in that the extraction of the components from the storage unit is computer-assisted by a robot which receives the storage position of the selected component from the data processing device.

10. The method according to claim 9 wherein the extraction by the robot is carried out by means of a computer-aided gripper device.

11. The method according to claim 1, characterized in that both components are vehicle components and the first component is first attached to the body of the vehicle and after selecting a suitable second component, this second component is attached to the body of the vehicle.

12. The method according to claim 1, characterized in that a computer-aided measurements carried out to obtain the actual data.

13. The method according to claim 12, characterized in that a tactile scanning and measuring or a 3D scanning for the acquisition of geometry data takes place, wherein the measuring device forwards the measured data via a data line to a data processing device.
